(19) United States
(12) Patent Application Publication
(10) Pub. No.: US 2025/0128252 A1
(43) Pub. Date: Apr. 24, 2025

(54) Methods and Systems for Preventing Cross Contamination and Improving Human Machine Interface of Pipette

(71) Applicants: Siriust Ling, REDWOOD CITY, CA (US); Asteris Ling, REDWOOD CITY, CA (US)

(72) Inventors: Siriust Ling, REDWOOD CITY, CA (US); Asteris Ling, REDWOOD CITY, CA (US)

(21) Appl. No.: 18/492,470

(22) Filed: Oct. 23, 2023

(51) Int. Cl. B01L 3/02; G06F 3/044

(52) U.S. Cl. CPC B01L 3/0237; B01L 3/0279; G06F 3/0446; B01L 2200/0605; B01L 2300/025; B01L 2400/0487

(57) ABSTRACT

A pipette has an electronic system that includes a capacitive sense array, a processing device and an electric switch. The processing device scans the sense array to obtain sense signals from the electrodes of the sense array when finger(s)/hand touch the sense array, generates images based on the sense signals and processes the images to classify if the touching finger(s)/hand is covered by materials such as nitrile/latex gloves other than bare skin. The electric switch can then turn on or off the pump based on these classifications. It can issue warning messages in the case of fingers being bare skinned and prompt corrective measures. Thus, prevents bare skinned hand contaminating the pipette. With the same sense signal, the processing device can also detect the motion parameters and recognize associated gestures of the touching fingers. The processing device can further adjust certain settings of the pipette according to the recognized gestures.

### TECHNICAL FIELD

The disclosed embodiments relate generally to electronic circuit, including but not limited to methods, systems, and devices for determining if a pipette is grabbed by a hand wearing gloves using a touch detection device, optionally, it can determine if liquid including moisture is present on the surface and can prompt or request a cleaning of the surface. Also optionally, it can set the desired volume by recognizing gestures of moving up or down by the user.

### TABLE OF NOTATIONS AND ABBREVIATIONS

For ease of description and brevity of the document, the following notations and abbreviations are listed below and will be used interchangeably with the original words in the subsequent text without further explicit definition and explanation.
CFR Code of Federal Regulations
OSHA Occupational Safety and Health Administration
RNA Ribonucleic Acid
RNases RiboNucleases
NBR acryloNitrile-Butadiene Rubber
HMI Human Machine Interface
SC Self-Capacitance
MC Mutual-Capacitance
TX Transmit
RX Receive
ADC Analog to Digital Converter/Conversion
DAC Digital to Analog Converter/Conversion
ASIC Application Specific Integrated Circuit
FPGA Field Programmable Gate Array
MCU Micro Controller Unit
CPU Central Processing Unit
PCB Printed Circuit Board
NVM Non-Volatile Memory
HW Hardware
FW Firmware
SW Software
LCD Liquid Crystal Display
LED/OLED Light-Emitting Diode/Organic Light-Emitting Diode
DSP Digital Signal/Image Processor/Processing
FSM Finite State Machine, State Machine
ML Machine Learning
NN Neural Network
CNN Convolutional Neural Network
RNN Recursive Neural Network
SVM Support Vector Machine
2D Two Dimensional
uL micro liter

### BACKGROUND

A pipette is a laboratory tool commonly used in chemistry, biology and medicine to transport a measured volume of liquid. The most fundamental functions of pipette are pumping and dispensing specified volumes of liquid. Functions associated with them are setting and adjusting the specific volumes. Its operation most commonly involves a human hand grabbing it. The basic requirements of pipette operation include: maintaining the purity of the liquid to ensure the correct experiment results; maintaining precision of the volumes of the liquid for the pipettes, especially micropipettes that move volumes in the range of 0.5-1,000 uL; and above all maintaining the safety of the operators. All these requirements will not be met if cross-contamination happens during operation of pipette.

Due to the environment in which the pipettes are used, cross-contamination by foreign substances can be introduced by grabbing and using the pipettes with bare skinned hands, i.e., not wearing gloves, and unwanted liquid on the pipettes. Therefore, bare hands operating pipettes poses serious contamination and safety issues. More specifically, human skin is an abundant source of RNases, an enzyme that degrades RNA. Common example use cases of pipette in lab environment include: working with RNA, bare hands operating pipette will lead to RNA degradation by RNases resulting in failure of experiments; working with sensitive genetic testing, e.g., forensic labs, bare hands can cross-contaminate the samples by introducing exogenous genetic material; doing sterile tissue culture, bare hands operating pipettes can contaminate the culture with bacteria and other micro-organism. Additional example use cases of pipette in lab working concerning lab safety include: working with potentially infectious/biohazardous materials (Biosafety Level 1-4), bare hands operating pipette poses serious safety issues for the operator due to exposure of bare skin to infectious and/or biohazardous materials from contaminated pipettes and is prohibited by OSHA regulation (Standards-29 CFR, 1910.1030); working with chemicals, potential exposure to the harmful chemical is high if the chemical is handled with bare hands operating pipettes and is also prohibited by OSHA Regulations (Standards-29 CFR, 1910.138). Aside from cross-contamination between pipettes and bare hands, unwanted liquid including droplets on the pipettes also can potentially carry contaminating substances that may be introduced to lab experiments.

Due to the importance of proper operation of the pipette, contemporary pipettes often have electronic or electric controls for pumping and volume settings. Some of these pipettes also have a touch sense array combined with digital display, e.g., touch screen, to improve HMI for the pipette operations by controlling its electronic functions, e.g., pumping and volume setting. Such touch sense array can detect touch but cannot classify the touch objects as fingers in gloves or bare skinned or liquid on the sensors. Therefore, such touch sense array cannot ensure proper and safe use of pipettes. A pipette with a system that can prevent cross-contamination will be an important step toward guaranteeing the safe use of pipette.

Yet another important aspect of pipette use is the adjustment of desired volumes. More recently, some electronic pipettes may have one or more virtual or real touch sensitive buttons for adjusting the volume. Such setups certainly improve the accuracy of the adjustments owing to the nature and advantages of the digital over analog control, but due to the limited dimensions of the pipettes, these buttons are also small and not easy to use especially when users wear gloves on their hands. A better user interface supporting more advanced HMI functions such as recognition of touch gestures, i.e., motions of the touch, is needed for such task.

### SUMMARY

This application is direct to systems, devices and methods that include one or multiple touch detection mechanism to determine if the grabbing hand has gloves on; if part of the surface has moisture/liquid on it; or if the user wants to increase or decrease the desired volume by certain amount.

Specifically, one or multiple capacitive touch sensors can be attached to the handle, i.e., the place where the user most often grabs with hands, and other parts of a pipette. These sensors can usually be arranged in certain patterns forming a capacitive sense array (referred to as “sense array” sometimes). The signals and/or images generated from these sensors can be used by a digital system that may use ML methods or traditional digital signal/image processing methods to determine if the object that touches the sensors is bare skin or certain type of glove, such as nitrile and if moisture or liquid is present on the sense array.

Capacitive sensor works by measuring the absolute capacitance (self-capacitance) or relative capacitance changes (mutual-capacitance) to the background capacitance between the touch object and the sensor. Adding non-conductive materials between the touch object and the capacitive sensor will reduce the magnitudes of the sense signal. Most commonly used gloves in labs currently are made of either NBR or latex, which are non-conductive (NBR has typical value of dielectric coefficient >10.), but these gloves are also sufficiently thin (average thickness of 0.002 inch or 0.05 mm), when contacting the sense array through the glove, the finger can still cause the sense array generating signals that can be detected by the sense circuitry and further processed by the processing device.

Due to the added layer of the glove material and its corresponding dielectric property, the aforementioned signal generated from the contact between the gloved fingers and the capacitive sense array are different and can be distinguished by either traditional DSP methods, such as filtering and slicing, or ML methods, such as NNs or SVMs, from signal generated by bare skinned fingers.

Since most types of liquid, especially water, is conductive but has different capacitive sensing responses from fingers, the presence of liquid can be detected from the capacitive sensing signal by DSP or ML methods similar to the ones used for detecting gloved or bare skinned fingers.

Gesture recognitions through motion parameter estimation can also be realized through capacitive sense array, thus enable improved HMI for pipette, e.g., a touch slider to set, increase and decrease the desired volume of the liquid for pipette.

Hence, a pipette should include a capacitive sense array including a plurality of sense electrodes. The pipette also includes a processing device, which couples to the capacitive sense array through a sensing circuit, is configured to perform scanning the capacitive sense array to obtain a plurality of capacitive sense signals from the plurality of sense electrodes of the capacitive sense array. The same or another processing device is further configured to generate an image of the capacitive sense array based on the plurality of capacitive sense signals and apply a digital signal/image processing method and/or a machine learning model implemented in HW, SW, FW or a combination thereof to process the image to determine if the objects that are touching the sense array is a gloved or bare skinned fingers, or if there is liquid present on the sense array. With such information, the processing device can then temporarily disable the pump(s) of the pipette for a predetermined time to allow the cleaning of pipette and issue a warning signal for potential contamination of pipette and a message that requests cleaning of the pipette.

As with many other electronic systems, temporary or permanent system failure due to the malfunctions of HW, SW or FW may happen. To prevent the loss of use, especially in emergency, an override button should be provided on pipette and can reactivate the pipette functions after the allowed time for pipette cleaning if it is not reactivated by the processing device.

Furthermore, the motion parameters of the touches that can be interpreted to change the settings of the pipette such as the volume. A touch sensitive slider bar then can be built on pipette for less than the size of two buttons and provide a simpler user interface for volume adjustment.

Other embodiments and advantages may be apparent to those skilled in the art in light of the descriptions and drawings in this specification.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 illustrates the general principle of capacitive touch sensing that is the conductive layers in the touch objects such as fingers, and the touched sensor(s) with all the in between dielectric layers such as glass and air, generate an equivalent capacitor and its capacitance can be measured and compared against the capacitance of the other untouched sensors, thus detect the touch.

FIG. 2A illustrates an example pipette that includes a capacitive sense array (referred to as “sense array” sometimes in the sequel), part of the array is under a display screen, while other part of the array is not, in accordance with some embodiments. The pipette also includes a processing device that is connected to the sensing array through one or more bi-directional links including DACs and ADCs.

FIG. 2B illustrates a similar example pipette that includes a real touch sensitive slider bar separate from the display screen as part of its user interface. FIG. 2C illustrates another similar example pipette that includes a virtual slider bar displayed on part of the display screen.

FIG. 3A illustrates an example diamond pattern used to form a capacitive sense array in accordance with some embodiments. FIG. 3B illustrates an example orthogonal electrode matrix used to form a capacitive sense array in accordance with some embodiments.

FIG. 4 shows an example sequence of interleaved capacitance scans and display scans that are controlled by the processing devices for the sense array and display screen, respectively.

FIG. 5 is a block diagram illustrating an example electronic system in a pipette having a processing device that controls the generation of and processes capacitive sense signals, in accordance with some embodiments.

FIG. 6A is an example flowchart of processing touch signals including determining if the touching object has a covering layer such as glove, or if the touching object is in fact moisture/liquid such as water drop, and also further controls the activation of the pipette pump, in accordance with some embodiments. It also can determine the motion parameters of the touch objects, and also further controls the settings of the pipette functions, such as volume, in accordance with some embodiments.

FIG. 6B is a detailed flowchart that illustrates an example method for utilizing ML models and DSP methods to determine if a detected touch is by bare skinned or gloved hand and/or the motion parameter of the touch over certain times.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits have not been described in detail so as not to unnecessarily obscure aspects of the embodiments.

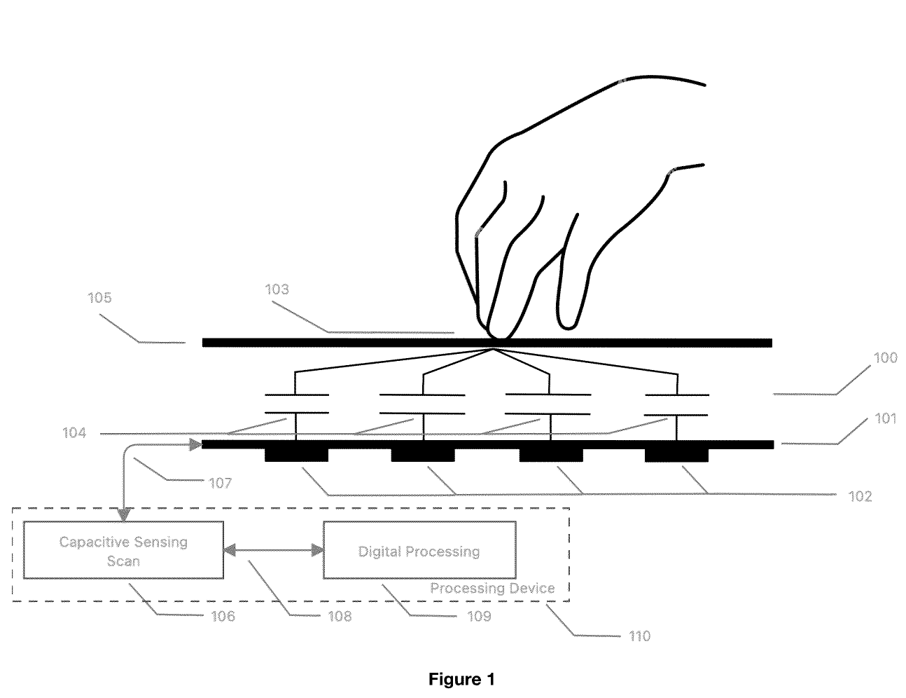

FIG. 1 is a diagram illustrating the concept of capacitive touch sensing with the partial side profile of a capacitive sense array 100, in accordance with some embodiments. In some embodiments, capacitive sense array 100 includes a plurality of sense electrodes 101, 102. When a touch object, such as a finger 103, approaches the surface 105 of capacitive sense array 100, the object causes a decrease in capacitance 104 between the object and some of the sense electrodes, typically referred to as mutual-capacitance. Furthermore, if the object is bigger or closer to the sensor array surface 105, the absolute value of this mutual-capacitance is bigger. In some embodiments, the presence of a finger increases the capacitance of the electrodes 101, 102 to the environment ground, typically referred to as self-capacitance. Similar to the mutual-capacitance, the closer the object to the sensor surface 105 or the bigger the object, the bigger the self-capacitance is. In some embodiments, the plurality of sense electrodes of the capacitive sense array 100 are configured to operate as TX electrodes 101 and RX electrodes 102 to detect touch objects.

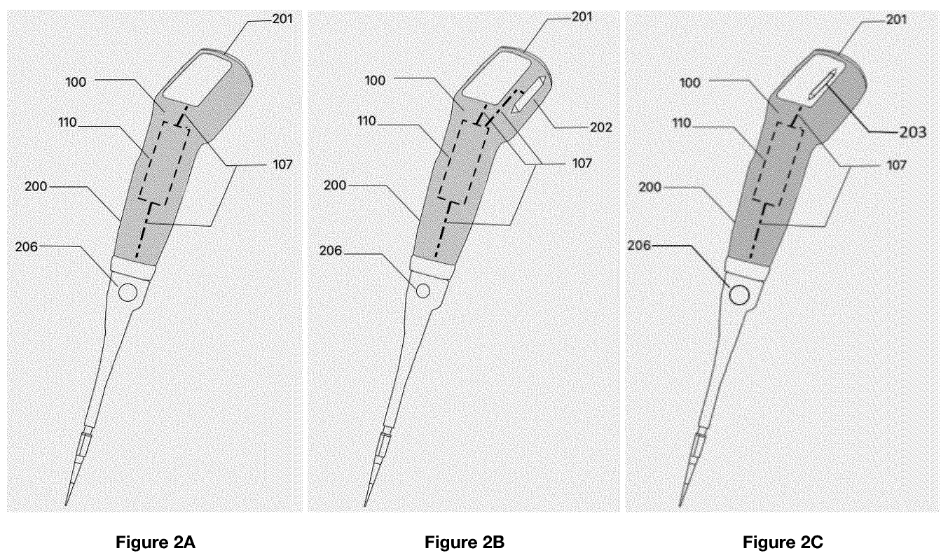

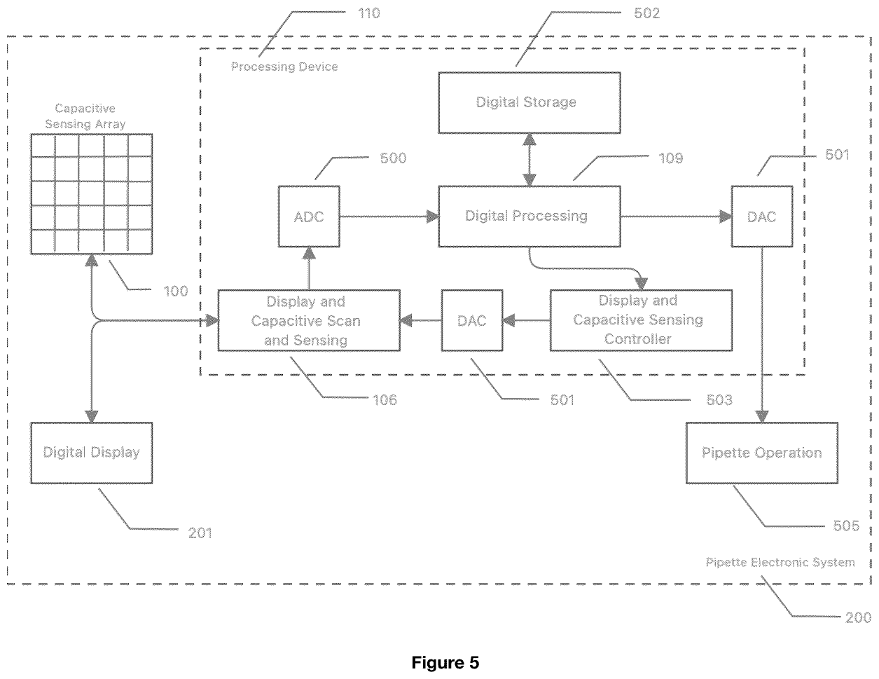

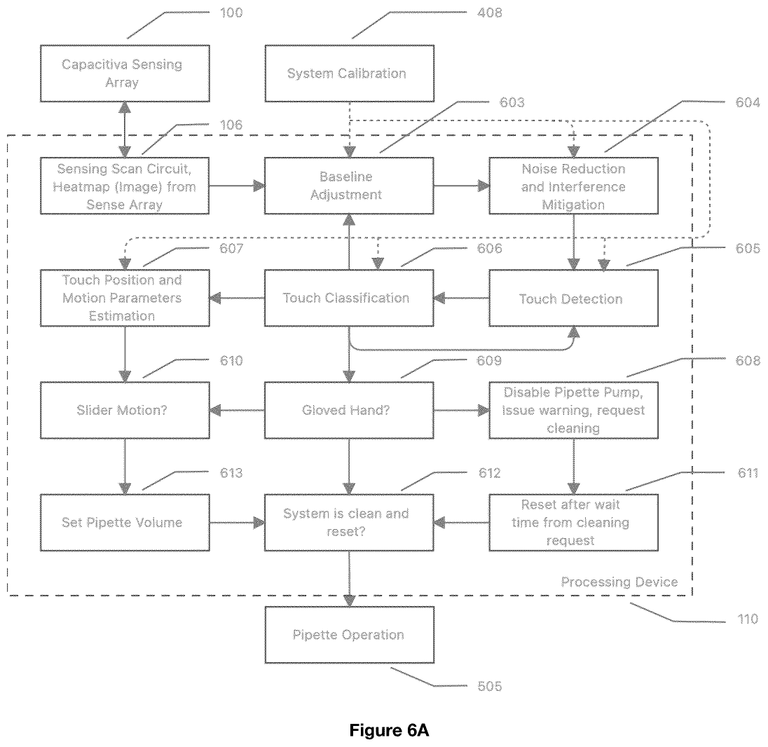

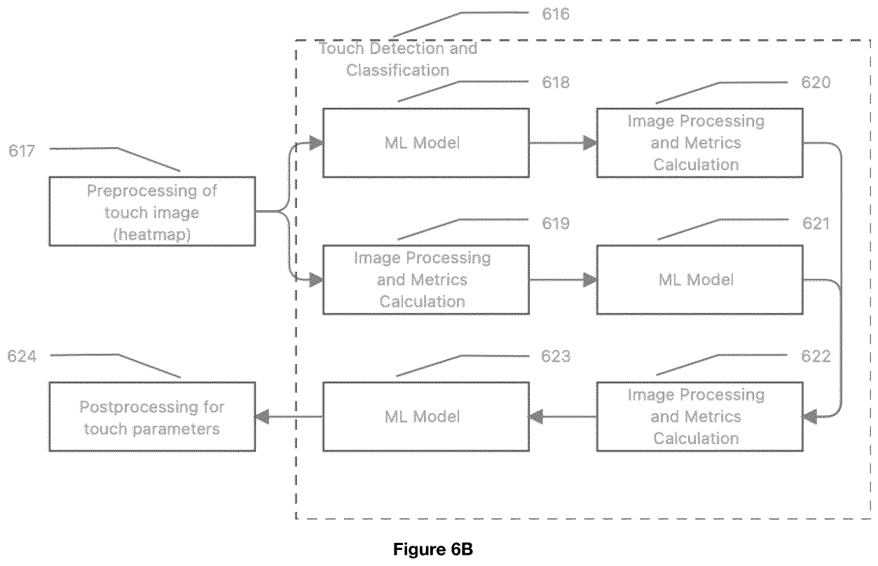

In some embodiments, the sense array 100 is connected through analog-digital mixed signal connection 107 to a processing device 110, which includes sensing scan circuit 106 and digital processing block 109. The sensing scan circuit 106 is connected to digital processing block 109 through mixed signal connection or data bus 108. In some embodiments, the sensing scan circuit 106, digital processing block 109 and their interconnections are implemented in a system, e.g., electronic system 200 (FIG. 2A), sometimes a single electronic device. In some embodiments, the processing device 110 may contain additional blocks to optimize performance. Some of the blocks are illustrated in FIGS. 5 and 6; other blocks may be apparent to those skilled in the art in light of descriptions and drawings in this specification.

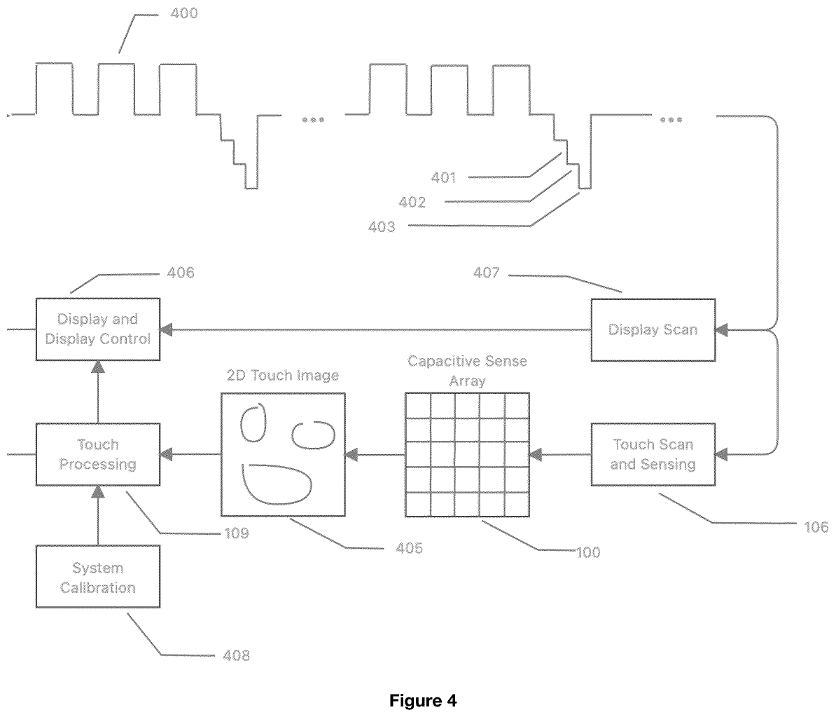

When an object, such as finger 103 is placed near the intersection of transmit electrode 101 and receive electrode 102, the presence of the finger will decrease the charge coupled between the object and the receive electrodes 102. During the sense scan, these capacitance changes are measured and compared to the capacitances of the same touch capacitive sense array 100 in an un-touched state to generate sense signals such as sense image 405 (FIG. 4). The capacitive sense signals are further processed by digital processing block 109 to determine the presence and location of touch. In some embodiments, the capacitive sense array 100 includes a matrix of N×M electrodes (N receive electrodes and M transmit electrodes), which includes transmit electrode 101 and receive electrode 102. Each intersection of TX electrode 101 and RX electrode 102 forms a unit cell of sensor. In some embodiments, a capacitive touch sensing system may collect data from the entire touch sensing surface of sense array 100 by performing a scan to measure capacitances of the unit cells in the touch sensing surface, then process the touch data serially or in parallel with a subsequent scan. For example, a system that processes touch data serially may collect raw capacitance data from each unit cell of the entire touch sensing surface, and filter the raw data. More precise coordinates then can be calculated based on the sense signal and dimension and geometry of the sense array 100. In some embodiments, the digital processing block 109 may find and use local maxima of the filtered raw data to calculate positions of touch objects, then perform post processing of the resolved positions to report locations of the conductive objects, or to perform other functions such as motion tracking or gesture recognition.

FIG. 2A illustrates a pipette with an electronic system 200 including the following main components, a capacitive sense array 100 (illustrated by the shadow/small dots), a processing device 110 and a digital display screen 201. Part of the sense array may also be part of or under an LCD or LED/OLED display panel, allowing the display screen functioning as a touch screen. The other part of the sense array can be exposed or under layers of materials that allow effective capacitive sensing. In some embodiments, the capacitive sense array 100 may include capacitive sense elements that are electrodes made of conductive material such as copper. The processing device 110 is connected or coupled with the sense array 100 and display 201 via digital bus or analog-digital mixed signal connection 107. The processing device 110 can be in the form of one or more PCBs with one or more integrated circuits such as MCUs, or CPUs, or DSPs or other electronic components or any combination thereof. More detail on this processing device will be discussed later with reference to FIG. 5B. According to some embodiments, the pipette 200 including the electric system, which further include sense array 100, processing device 110, display 201, etc. can be powered by a built-in rechargeable battery similar to other portable electronic devices such as cell phones. Additionally, a reset/clear/override button 206 is built in the pipette to allow resetting or clearing the state of the electronic system 200 and enabling the use of pipette pumping functions by overriding the processing device 110 in the case of system failure of the capacitive sensing array 100 and the processing device 110.

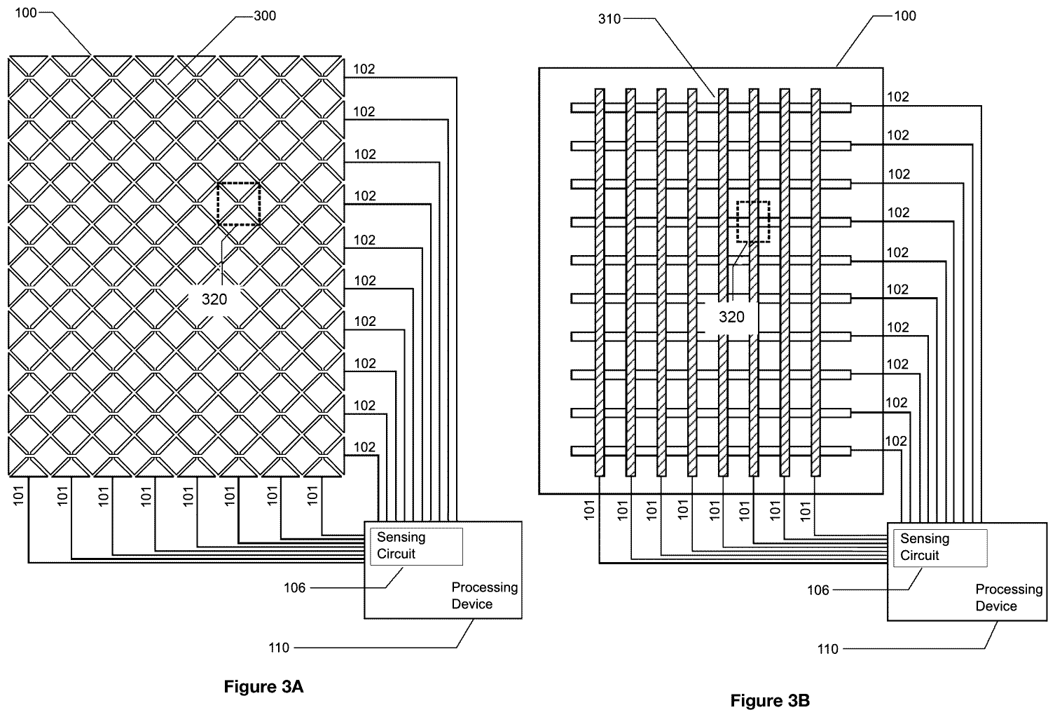

The capacitive sense elements can be used to allow the capacitance sense circuit 101 to measure self-capacitance, mutual-capacitance, or any combination thereof, and the capacitive sense array 100 is configured to provide capacitive sense signals to the processing device via analog-digital mixed signal connection 107. In some embodiments, part of the capacitive sense array 100 is a non-transparent capacitive sense array (e.g., part of the outside cover of a pipette). The capacitive sense array 100 may be disposed to have a flat or a non-flat surface profile such as conforming to a curvature. In some embodiments, other configurations of capacitive sense arrays are be used. For example, instead of vertical columns and horizontal rows, the capacitive sense array 100 may have a hexagon arrangement, or the like, as would be appreciated by one of ordinary skill in the art having the benefit of this disclosure. More details on a capacitive sense array 100 are explained below with reference to FIG. 3A-3B.

FIG. 2B illustrates a pipette with a capacitive sense array 100 and a display screen 201. Part of the sense array area is marked out with sliding bar shaped signs 202 that may include arrow shaped direction marks. Touch gestures occurring and being detected in the marked region can be interpreted as function control of the pipette, such as increasing or decreasing the volume.

FIG. 2C illustrates a pipette similar to the one in FIG. 2B. The only difference is the marks for the sliding bar are virtual marks 203 that are displayed on the display screen 201 and the start, ending and duration of the display are controlled by the processing device 110 in the pipette, similar to virtual buttons on a smart phone.

FIG. 3A illustrates a solid diamond pattern 300 used to form a capacitive sense array 100 in accordance with some embodiments. FIG. 3B illustrates an example orthogonal electrode matrix 310 used to form a capacitive sense array 100 in accordance with some embodiments. When the solid diamond pattern 300 or the orthogonal electrode matrix 310 is applied in a capacitive sense array 100, the capacitive sense array 100 includes a plurality of RX sense electrodes 102 arranged in rows and a plurality of TX sense electrodes 101 arranged in columns. In some embodiments, the TX electrodes 101 are arranged in rows and the RX electrodes 102 are arranged in columns instead. The sense electrodes 101-102 are connected to a capacitance sensing circuit 106 included in a processing device 110 by the mixed signal connection 107, and configured to provide sense signals to the processing device 110. Mutual-capacitances or self-capacitances can be measured by the sensing circuit 106 at each intersection 320 between the TX electrodes 101 and the RX electrodes 102. The measured mutual-capacitances or self-capacitances are further processed at the processing device 110 to determine higher resolution locations of one or more contacts on the capacitive sense array 100.

Additionally, although the row and column electrodes appear as bars, elongated rectangles or diamonds in FIGS. 3A and 3B, various tessellated shapes (e.g., rhomboids and chevrons) may also be used.

Optionally, the sensor pattern is a diamond pattern 300 (FIG. 3A) or a row-column pattern 310 (FIG. 3B). The capacitive sense array 100 formed from the sensor pattern 310 includes row and column sense electrodes that can be expressed as a matrix of the intersections between row and column electrodes. In some embodiments, the row and column sense electrodes are formed on two conductive layers that are electrically insulated from each other, and both of the conductive layers are formed on one of the top or bottom surfaces of the glass. The size of the capacitive sense array 100 is expressed as the product of the number of columns and the number of rows. For example, when a sense array 100 has N row electrodes and M column electrodes, the number of intersections is N×M, the same as the size of the sense array 100. During a capacitive scan, each of the electrodes in the matrix 310 is configured to receive a transmission signal from the capacitance sense circuit 106, and/or provide a capacitive sense signal to the capacitance sense circuit 106.

In some embodiments, the capacitance sense circuit 106 and the processing device 110 can be configured to detect multiple touches. One technique for the detection and location resolution of multiple touches uses a two-axis implementation: one axis to support rows and another axis to support columns. Additional axes, such as a diagonal axis, implemented on the surface using additional layers, can also be used. In the touch sensing state, SC or MC of sense electrodes of the capacitive sense array 100 is scanned. One or more touch locations are thereby detected if one or more objects touch the touch sensing surface of the electronic system illustrated in FIG. 5.

FIG. 4 illustrates an example sequence of display scans interleaved with various capacitive sensing scans, in accordance with some embodiments. A sequence of sensing scans may include SC scans 401 and MC scans 402 and 403. These sensing scans may also be alternated between scan for one part, MC scan 402, and other parts of the array, MC scan 403, e.g., the part under the display screen and the part not under the display screen. The MC scans 402, 403 and SC scan 401 are applied to detect whether the touch objects touch, or hover above, a touch sensing surface of the capacitive sense array 100. In some embodiments, the sequence of capacitive sense scan follows, or is followed by display scan 400. During display scan 400, a plurality of display drive signals is generated to drive the plurality of display elements. Further, in some embodiments, the time allotted to the capacitance scan is less than a threshold portion e.g., 60%, of the time allotted to the display scan. In some embodiments, the sequence of capacitive sense scans 401, 402, 403 are implemented by the processing device 110, and provide a plurality of capacitive sense signals. More specifically, during each run of capacitive sense scans, the sensing signals from the respective capacitive sense scans are processed to obtain a frame of touch image 405. When a touch object e.g., finger 103 is near the sense array 100, touch image 405 is an image of the touch object 103. This 2D capacitive image 405 is further processed by the processing device 110 to determine touch events on the surface of capacitive touch sense array 100. Further, in some embodiments, the 2D capacitive image 405 is a combination of the capacitive sense signals collected from all of the electrodes of the sense array 100. Or alternatively, the 2D capacitive image 405 is a subset of the capacitive sense signals. This signal subset corresponds to the subset of capacitive sense electrodes, which is in proximity to or in contact with the finger 103 and less than all of the electrodes of the sense array 100.

The configurations of the scan including the timing, frequency and duration are controlled by a state machine in the processing device. The configurations of the scan can also be calibrated by the processing device alone or when the pipette is in a calibration process in conjunction with another separate processing device 408 such as a computer.

FIG. 5 illustrate an example block diagram of pipette electronic system 200 includes a capacitive sense array 100, digital display 201, pipette operation 503 (pumping etc.) and processing device 110, which further includes digital processing block 109, touch and display controller block 406, touch scanner circuit 106 and analog and digital mixed signal blocks such as ADC 500 and DAC 501. The digital processing block 109 is configured to detect one or more touches proximate to a touch sensing device, such as capacitive sense array 100. The digital processing block 109 can detect conductive objects including objects with relatively weaker conductivity, such as bare skinned or gloved fingers or water/liquid, or any combination thereof. The sense scan circuit 106 can measure touch data created by a touch object 103 using the capacitive sense array 100. The touch may be detected by a single or multiple sensing cells, each cell representing an isolated sense element or an intersection of sense elements (e.g., electrodes) of the sense array 100. In some embodiments, when the capacitance sense circuit 106 measures mutual or self-capacitance of the touch sensing device (e.g., sense array 100), the processing device 110 acquires a 2D capacitive image 405 of the touch object and processes the capacitive image data for types of objects and positional information. In some embodiments, touch detection FW and/or SW executing on microcontrollers identify data set areas that indicate touches, detects and processes peaks, estimates area being touched, calculates the touch coordinates, or any combination thereof. The processing device 110 can report the types of touching objects and other associated touch status such as location and motion to an application processor.

In some embodiments, the components of the processing device 110 may be one or more separate integrated circuits and/or discrete components. In some embodiments, the processing device 110 may be one or more other processing devices known by those of ordinary skill in the art, such as a general purpose or a specific-purpose microprocessor or controller, a DSP, an ASIC, a FPGA, or the like.

In some embodiments, the FW and/or SW that is executed on the digital processing block 109 is pre-stored in digital storge 502, which can be implemented using NVM such as flash memory. Additionally, some data in the processing may be stored in digital storage 502 for diagnostic purposes.

It is noted that the components of the electronic system 200 in the pipette may include all or fewer than the components described above. The illustration is not meant to be exhaustive, some components, such as a data bus connecting to a host computer are not illustrated here but can be recognized by people skilled in the art.

Some or all of the operations of the processing device 110 may be implemented in FW, SW, HW, or some combination thereof. The digital processing block 109 may receive signals from the sense circuit 106, determine the state of the capacitive sense array 100 (e.g., determining whether an object is detected on or in proximity to the touch sensing surface), determine the location of the object with respect to the sense array 100, or generate other information related to an object detected at the sense array 100. It should be noted that even though the sensing scan circuit 106 is depicted as part of the processing device 110 in FIGS. 1, 5 and 6A, in some embodiments, the sensing scan circuit can be a component separate from the processing device 110 in the pipette electronic system 200. Further, the components of the mixed signal link 108 between the sensing circuit 106 and the digital processing block 109, such as ADC 500 and DAC 501 can either be stand alone or part of the sensing circuit 106 or part of the digital processing block 109.

FIG. 6A is a flow chart of an example processing of capacitive sense signals by a processing device, in accordance with some embodiments.

In some embodiments, the processing device 110 calibrates the sensors (intersections of RX and TX electrodes) by determining baselines, which is the sense signal when there is no touch present, for the sense elements. In some embodiments, the baseline associated with each combination of TX and RX electrodes is adjusted individually according to a surface condition at a corresponding location of the touch sensing surface (e.g., whether the corresponding location is covered by a water drop). In some embodiments, the processing device alone or when the pipette is in a calibration process in conjunction with another separate processing device such as a computer 408 can also adjust the settings and parameters of all the algorithms including DSP and ML methods 603, 604, 605, 606 and 607 for optimal performance. Since all high precision pipettes need periodic calibration to ensure their accuracy, the calibration of electronic system 200 can be done at the same time interval with regular pipette precision calibration.

In some embodiments, the processing device 110 applies DSP to the sensing image to reduce noise and interferences originating from the electronic circuitry such as display 508 and the surrounding environment. The post-processed image is further processed by another DSP or ML model to determine the motion parameters, such as positions, motion directions and velocity of the finger on the surface of the capacitive sense array 100 and based on the plurality of capacitive sense signals. For example, the plurality of capacitive sense signals is adjusted based on corresponding baseline values, and a subset of capacitive sense signals are compared with one or more capacitive signal thresholds to determine whether a gloved finger touches or hovers on the surface of the sense array 600. In this example, the ML models and DSP configuring a capacitive sense array 600 to detect touch objects and determine the motion parameters such as direction and distance of the touch object(s) and further use these parameters to configure the control functions of the pipette such as volume adjustments, in accordance with some embodiments.

For any processing of the capacitive sense signal, a FSM based on multiple images can be used conjunctively to improve the accuracy in accordance with some embodiments.

In some embodiments, a mechanism is needed to ensure the usability of the device in the case of malfunction of system and components including HW, SW and FW. Since the capacitive sense array and the processing device can control the essential functions of the pipette, an override or a reset mechanism such as a real button 206 can be built into the pipette to maintain the use of pipette by activating/reactivating the pipette functions in the case of failure of detecting gloved hands or non-presence of liquid caused by capacitive sense system malfunction, in accordance with some embodiments. This mechanism 611 is illustrated in FIG. 6A. Other diagnose and fault handling components not described here should be apparent to one of ordinary skill in the art.

According to some embodiments, to achieve the optimal performance of the electronic system, its functions should be calibrated from time to time to ensure it adapts to the changing environment in which it operates.

FIG. 6B is a flowchart of an example method for touch detection and classification 616 (also 605, 606) for using a combination ML models 618, 621, 623, and image processing methods 619, 620, 622. As illustrated by the figure, in some embodiments, the processing device applies a single or multiple ML models 618, 621, 623 or DSP/image processing methods 619, 620, 622 to process the image 405 to determine if the finger 103 is actually touching or just hovering over the sensing surface, and furthermore if the finger(s) are bare skinned or in a glove or if the touch is caused by moisture/water drop. In some embodiments, the ML models 618, 621, 623, include a CNN including a plurality of 2D convolutional layers. In some embodiments, the ML model 618, 621, 623, include one or more of: a single stage or multi-stage SVM, a RNN, a residual network (ResNet), and an encoder-decoder network, e.g., a U-net. In some embodiments, the ML models 618, 621, 623 are trained by separate computers before being used, and provided to the processing device 601 to process the image 405. This process is included in the illustrated system calibration 615 in FIG. 6A. In some embodiments, the ML models 618, 621, 623 are stored in local memory of the electronic system 509, and extracted from the local memory to process the image 405. These ML models 618, 621, 623 and image processing methods 619, 620, 622 can be arranged in sequential, parallel or any combination thereof. In some embodiments, more or fewer ML models 618, 621, 623 and/or DSP methods 619, 620, 622 may be included in the touch detection and classification process 616. In some embodiments, other processes such as baseline adjustment 603, noise reduction 604 and touch position estimation 607 may employ similar structure as touch detection and classification 616.

Each frame of touch data includes a set of data calculated based on capacitive sense signals that are measured from the respective sense scan. In some embodiments, the sense data has a finite digital resolution in certain number of bits, e.g., 16-bit. One or more capacitive sense scans provide a set of sense data of a touch object., e.g., the image 405. In some embodiments, various algorithms are optionally used by the processing device 110 to detect a central location of a touch with better resolution than a spatial pitch of the sense array 100. Additionally, a raw resolution of sense array 100 is the same as the size of unit cell 320, and a post-processing resolution of the sense array 100 is finer. For example, the size of each unit cell 320 is 4.5 mm, then the raw resolution of the sense array 100 is 4.5 mm, and the post-processing resolution can be less than ½ mm. More touch information associated with touches of the finger 103, optionally includes position, orientation, velocity and traveled distance, can also be extracted from the set of touch data. Subsequently, multiple frames can be used to improve the quality and stability of the information obtained by DSP 619, 620, 622 and/or ML methods 618, 621, 623. These frames can be consecutive or non-consecutive.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although some of various drawings illustrate a number of logical stages and/or a number of operations in a particular order, stages and operations that are not order dependent may be reordered and/or combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in HW or FW or SW or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An electronic system for monitoring finger or hand touch events on a pipette, comprising: a single or a plurality of capacitive sense arrays; and a single or a plurality of processing devices coupled to a capacitive sense array; wherein the capacitive sense array includes a plurality of sense electrodes that are configured to obtain a plurality of capacitive sense signals by scanning the capacitive sense array, and generate a single or a plurality of images of the capacitive sense array based on the capacitive sense signals; and the processing device is configured to control the functions of the pipette, including enabling or disabling liquid pumping function, based on the information obtained from the capacitive sense signals and images.

2. The electronic system according to claim 1, is configured to determine a touch of the pipette to a bare skinned hand or a hand in a glove by applying a digital signal/image method or machine learning model to process the capacitive sense signals, enable the pumping functions of the pipette if the touch is between the pipette and a hand in a glove, and disable the pumping function of the pipette if the touch is between the pipette and a bare skinned hand.

3. The electronic system according to claim 2, is further configured to determine a thickness of the glove by applying a digital signal/image processing method or machine learning model to process the capacitive sense signal, enable the pumping functions of the pipette if the thickness is below a preestablished value, and disabling the pumping function of the pipette if the thickness is above a preestablished value.

4. The electronic system according to claim 1, is configured to determine a touch state parameter of the pipette by applying a digital signal/image method or machine learning model to process the capacitive sense signal; wherein the touch state parameter includes liquid or moisture presenting or not presenting on part of the pipette and/or part of the capacitive sense array.

5. The electronic system according to claim 4, wherein the touch state parameters further include motion parameters of the touch, that comprise the positions of the touch, speeds of the touched objects and distances traveled by the touched objects; wherein the motion parameters are interpreted and recognized as gestures, which can be used to configure the operation settings of the pipette, including increasing or decreasing the volume by certain amount.

6. The electronic system according to claim 2, wherein the processing device comprises a single or a multiple machine learning models; wherein the machine learning model includes Convolutional Neural Network, Support Vector Machine, Recursive Neural Network, or a combination thereof.

7. The electronic system according to claim 1, further comprising a calibration process by applying the parameters obtained from the processing device on the pipette, or the processing device on the pipette and another separate processing device; wherein a touch monitoring process with digital signal/image processing, a machine learning model or a combination thereof is applied.

8. The electronic system according to claim 1, wherein the capacitive sense signal includes a plurality of subsequent images, some of the images that precede before others, upon which a sequence of digital signal/image processing, machine learning model, or a combination thereof are applied to and the results are used to improve a touch monitoring process for the subsequent images.

9. The electronic system according to claim 1, further comprises hardware or firmware or software, or a combination thereof, to assist an operation of the pipette.

10. The electronic system according to claim 1, further comprises an override/clear/reset mechanism including a real button built into the pipette so that the detection of touching hand in glove and/or non-presence of liquid on pipette can be overridden to enable normal uses of the pipette.

11. The electronic system according to claim 1, further comprises an electric switch coupled to and activated by the processing device, to enable or disable the pumping function of the pipette.

12. A pipette comprises the electronic system according to claim 1.
